(19) United States
(12) Patent Application Publication
(10) Pub. No.: US 2026/0048787 A1
(43) Pub. Date: Feb. 19, 2026

(54) Method for Assuring a Change in a Variable Steering Ratio of a Steering System

(71) Applicant: Robert Bosch GmbH, Stuttgart (DE)

(72) Inventors: Arnulf Heilig, Schwaebisch Gmuend (DE); Arjun Viswanathan, Gaildorf (DE); Daniel Goebbel, Pluederhausen (DE); Florian Elsner, Fellbach (DE); Frank Bieg, Moegglingen (DE); Haiyan Lu, Schwaebisch Gmuend (DE); Hendrik Buering, Mutlangen (DE); Marcel Lazecky, Aalen-Waldhausen (DE); Michael Boensch, Heubach (DE); Patrick Henreich, Heubach (DE); Rainer Biegert, Boehmenkirch (DE); Swaminathan Ganapathi Subramanian, Coimbatore (IN)

(21) Appl. No.: 19/297,972

(22) Filed: Aug. 12, 2025

(30) Foreign Application Priority Data
Aug. 14, 2024 (DE) 10 2024 207 743.7

(51) Int. Cl. B62D 6/00

(52) U.S. Cl. CPC B62D 6/002

(57) ABSTRACT

A steering system is configured as a steer-by-wire steering system and includes an operating unit having at least one steering handle as well as at least one wheel steering angle control element operatively connected to the operating unit for changing a wheel steering angle of at least one vehicle wheel. The variable steering ratio defines an adjustable gear ratio between a steering specification on the steering handle and the wheel steering angle of the vehicle wheel. In a method for assuring a change in the variable steering ratio in the steering system, particularly during operation of the steering system in a vehicle, the change in the variable steering ratio is limited by a dynamically determined change characteristic.

This application claims priority under 35 U.S.C. § 119 to application no. DE 10 2024 207 743.7, filed on Aug. 14, 2024 in Germany, the disclosure of which is incorporated herein by reference in its entirety.

### BACKGROUND

The disclosure relates to a method for assuring a change in a variable steering ratio of a steering system. The disclosure also relates to a computing unit for performing such a method and a vehicle comprising such a computing unit.

Vehicles with conventional steering systems are known from the prior art, in which a steering handle, for example in the form of a steering wheel, is mechanically connected to a wheel steering angle control element in the form of a steering gear via a steering column. Also known are vehicles comprising steer-by-wire steering systems which do not require a direct mechanical connection between a steering handle and the steered vehicle wheels and in which a steering specification is only transmitted electrically. A steer-by-wire steering system of this type usually comprises an operating unit with a steering handle and a feedback actuator as well as at least one wheel steering angle control element that is mechanically separate from the operating unit and can, e.g., be designed as a central regulator or as a single-wheel controller.

Such a steer-by-wire steering system provides the advantage that a steering ratio, or gear ratio, between a steering specification on the steering handle and a wheel steering angle of the vehicle wheel can be varied depending on the driving situation, for example, depending on the steering angle and vehicle speed. Thus, it is possible to realize a more indirect steering translation at higher vehicle speeds than at low vehicle speeds, for example, and thus achieve better driving behavior. DE 10 2017 220 803 B4 discloses such a steer-by-wire steering system with variable steering ratio.

However, one challenge is to assure the change in the variable steering ratio since limitation by means of a fixed value, as is currently the case, presents various problems.

Based on this, the task of the disclosure is, in particular, to provide a method for assuring a change in a variable steering ration with improved properties in terms of efficiency. The problem is solved by the features disclosed herein.

### SUMMARY

The disclosure relates to a method for assuring a change in a variable steering ratio in a steering system, particularly during operation of the steering system in a vehicle, wherein the steering system is configured as a steer-by-wire steering system and comprises an operating unit having at least one steering handle as well as at least one wheel steering angle control element operatively connected to the operating unit for changing a wheel steering angle of at least one vehicle wheel, and wherein the variable steering ratio defines a gear ratio between a steering specification on the steering handle and the wheel steering angle of the vehicle wheel, which can be particularly adjusted dynamically adjusted and/or as a function of the driving situation. The steering ratio can be varied, for example, as a function of a steering specification, in particular a dynamic and/or an absolute value of the steering specification, and/or as a function of a vehicle speed, and consequently be variably adjusted.

It is proposed that the change in the variable steering ratio be limited by means of a dynamically determined change characteristic. According to the present disclosure, the change characteristic is designed to be variable and accordingly dynamically adaptable. Particularly preferably, the change in the variable steering ratio in this context is made using a change factor, wherein the change factor is limited by the change characteristic. This configuration may improve efficiency, particularly performance efficiency and/or operational efficiency. In particular, the adjustable limit to the change in steering ratio may increase operational safety while simultaneously improving performance. Moreover, by means of situational adjustment of the change characteristic, movement of the vehicle wheels can be prevented, particularly with a consistent deflection of steering handle and change in the change factor, for example when accelerating the vehicle as the change factor changes by means of the vehicle speed. In addition, it is advantageous to switch from a first steering ratio to a second steering ratio in a safe and efficient manner.

In the present case, the steering system is preferably designed as a steer-by-wire steering system, in which a steering specification, in particular from a driver, is advantageously transmitted purely electrically to the vehicle wheels. The term “wheel steering angle control element” is to be particularly understood as an actuator unit mechanically separated from the operating unit and coupled to at least one vehicle wheel, which is intended to transmit a steering specification, in particular of a driver, to the vehicle wheel by changing a wheel steering angle of at least one vehicle wheel and thereby advantageously control at least one alignment of the vehicle wheel and/or influence a direction of travel of the vehicle. To this end, the wheel steering angle controller advantageously comprises at least one steering regulator element, for example in the form of a gear rack, and at least one steering actuator, for example in the form of an electric motor, which is operatively connected to the steering regulator element. The wheel steering angle control element can be designed as a central regulator and be assigned to at least two vehicle wheels, in particular steerable and preferably designed as front wheels. Alternatively, however, the wheel steering angle control element can also be designed as a single-wheel controller and assigned to exactly one vehicle wheel, in particular a steerable wheel, preferably designed as a front wheel. The term “steering ratio” is further understood to mean a, in particular virtual, gear ratio between the operating unit and the wheel steering angle control element, which defines a correlation between a steering specification on the steering handle and a wheel steering angle of the vehicle wheel and/or the vehicle wheels. The steering ratio therefore influences how a deflection of the steering handle or a steering angle of the steering handle affects a deflection of the vehicle wheel and/or the vehicle wheels or a steering angle of the vehicle wheel and/or the vehicle wheels. For example, a first steering ratio may provide more direct or a tighter steering response, while a second steering ratio may provide more indirect or a less tight steering response.

Furthermore, the vehicle comprises at least one computing unit, which is intended to perform the method for assuring the change in the variable steering ratio. The term “computing unit” is mainly understood to mean an electrical and/or electronic unit having an information input, information processing, and an information output. Advantageously, the computing unit also has at least one processor, at least one operating memory, at least one input means and/or output means, at least one operating program, at least one control routine and/or regulation routine, at least one calculation routine, at least one determination routine, at least one adaptation routine and/or at least one limitation routine. In particular, the computing unit is provided at least for limiting the change of the variable steering ratio by means of a dynamically determined change characteristic, in particular by means of the limitation routine. Moreover, the computing unit may be provided for, in particular, changing and/or modifying the steering ratio between the operating unit and the wheel steering angle control element by means of the determination routine, the change characteristic, and/or in particular by means of the adaptation routine. Preferably, the computing unit is integrated into a control device of the vehicle, for example a central vehicle control device, or a control device of the steering system. The term “intended” is to be understood in particular as specially programmed, designed and/or equipped. The fact that an object is intended for a specific function should be understood in particular to mean that the object fulfills and/or executes this specific function in at least one application and/or operating mode.

It is further advantageously proposed that a time change gradient be used as the change characteristic. Accordingly, a dynamically adjustable change gradient is preferably used to limit the change in the steering ratio, and more preferably to limit the change factor. Therefore, the change in the variable steering ratio is assured by means of a variable, time gradient limitation. In particular, a simple assurance of the change in the steering ratio, which is advantageous in terms of control technology, can be achieved as a result.

Furthermore, it is proposed that the change characteristic is determined dynamically and in particular calculated depending on a steering specification, in particular a current specification, on the steering handle, in particular a dynamic and/or an absolute value of the steering specification. The dynamics of the steering specification may in particular correspond to a steering speed of the steering handle or a steering angle speed when a steering wheel is used as the steering handle. The absolute value of the steering specification may in particular correspond to a deflection of the steering handle or a steering angle when a steering wheel is used as the steering handle. An advantageously dynamic or situation-dependent determination of the change characteristic can thereby be achieved.

Particularly high performance and/or operational safety can in particular be achieved if the change characteristic is determined as a function of at least two partial characteristics, wherein a first partial characteristic of the partial characteristics is determined as a function of a deflection of the steering handle and a second partial characteristic of the partial characteristics is determined at least as a function of a steering speed of the steering handle. Preferably, in this case, the change characteristic is determined as a function of a maximum value from the first partial characteristic and the second partial characteristic. In principle, the maximum value can also be used directly as a change characteristic. In addition, a deflection of the steering handle may also be considered when determining the second partial characteristic. In the present case, the second partial characteristic can thus preferably be determined solely as a function of the steering speed of the steering handle or as a function of the deflection of the steering handle and the steering speed of the steering handle. If a time change gradient is used as the change characteristic, the first partial characteristic may also advantageously correspond to a minimum gradient, while the second partial characteristic may correspond to a maximum gradient.

Alternatively, it is suggested that the change characteristic be determined using a characteristic map which maps at least one deflection of the steering handle against a steering speed of the steering handle. The characteristic map can preferably be pre-applied and stored, for example, in an operational memory of the vehicle. If a time change gradient is used as the change characteristic, a 3D characteristic map for gradient limitation can thus advantageously be used. As a result, an advantageously simple determination of the change characteristic can be achieved. In addition, required computing resources may be reduced.

The method for assuring the change in the variable steering ratio and the vehicle are not intended to be limited to the application and embodiment described above. In particular, the method for assuring the change in the variable steering ratio and the vehicle in order to achieve the functioning described herein may comprise a number of individual elements, components, and units that differ from the number specified herein.

### BRIEF DESCRIPTION OF THE DRAWINGS

Further advantages follow from the description of the drawings below. The drawings show an exemplary embodiment of the disclosure.

The figures show:

FIGS. 1a-b a vehicle with a steering system designed as a steer-by-wire steering system in a simplified representation,

FIG. 2 a signal flow diagram for assuring a change in a variable steering ratio of the steering system; and

FIG. 3 an exemplary flowchart showing main method steps of a method for assuring the change in the variable steering ratio of the steering system.

### DETAILED DESCRIPTION

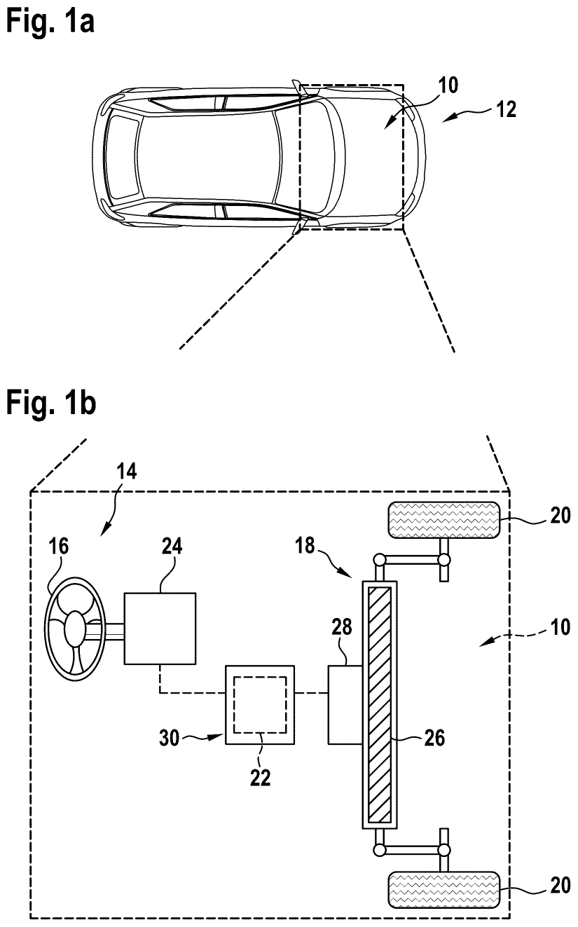

FIGS. 1a and 1b show a simplified illustration of a vehicle 12 which is, e.g., designed as a passenger vehicle comprising a plurality of vehicle wheels 20 and a steering system 10. The steering system 10 is operatively connected to the vehicle wheels 20 and is provided to influence a direction of travel of the vehicle 12. Furthermore, the steering system 10 is designed as a steer-by-wire steering system in the present case, in which a steering specification is transmitted electrically to the vehicle wheels 20 in at least one operating state.

The steering system 10 comprises an operating unit 14, in particular actuatable by a driver and/or an occupant. The operating unit 14 comprises a steering handle 16, for example, in the form of a steering wheel, and a feedback actuator 24 which is mechanically coupled to the steering handle 16. The feedback actuator 24 is provided to provide an active feedback torque and thereby to generate a steering resistance and/or a restoring torque on the steering handle 16. A steering handle could alternatively also be designed as a joystick, a steering lever, and/or as a steering ball or the like.

The steering system 10 further comprises a wheel steering angle control element 18. The wheel steering angle control element 18 is mechanically separate from the operating unit 14. The wheel steering angle control element 18 is purely electrically connected to the operating unit 14. Furthermore, the wheel steering angle control element 18 is designed as a central actuator in the present case. The wheel steering angle control element 18 is operatively connected to at least two of the vehicle wheels 20, in particular two front wheels, and is intended to convert the steering specification into a steering movement of the vehicle wheels 20. To this end, the wheel steering angle control element 18 includes a steering control element 26, particularly in the form of a gear rack, and a steering actuator 28, particularly in the form of an electric motor, that cooperates with the steering control element 26. A steering system could in principle also comprise a plurality of wheel steering angle control elements, in particular designed as single wheel actuators. Furthermore, a steering actuator could be configured as, for example, a linear drive and/or comprise a plurality of electric motors.

The vehicle 12 further comprises a control device 30. In the present case, the control device 30 is designed as a steering control device and is therefore part of the steering system 10. The control device 30 comprises an electrical connection to the wheel steering angle control element 18. The control device 30 also comprises an electrical connection to the operating unit 14. The control device 30 is provided at least for controlling an operation of the steering system 10. The control device 30 comprises a computing unit 22 for this purpose. The computing unit 22 comprises at least one processor (not depicted), e.g., in the form of a microprocessor, and at least one operating memory (not depicted). In addition, the computing unit 22 also comprises at least one operating program stored in the operating memory with at least one control routine, at least one calculation routine, at least one determination routine, at least one adaptation routine, and at least one limitation routine. A control device could in principle also be different from a steering control device and designed, e.g., as a single, central vehicle control device having a central computing unit. It is also conceivable to provide separate control devices and/or computing units for one wheel steering angle control element as well as one operating unit and communicatively interconnect them.

The present steering system 10 provides the advantage that a steering ratio or the gear ratio between the steering specification on the steering handle 16 and the wheel steering angle of the vehicle wheel 20 can be varied depending on the driving situation, for example, depending on a deflection of the steering handle 16 and a vehicle speed. The variable steering ratio is a degree of freedom not found in conventional steering systems. Thus, it is possible to realize a more indirect steering translation at higher vehicle speeds than at low vehicle speeds, for example, and thus achieve better driving behavior.

At the same time, it is necessary to effect the change in the variable steering ratio, which can be carried out, for example, via a corresponding factor. To this end, the change in the variable steering ratio or factor, for example, can be limited by means of a change characteristic in the form of a fixed, time change gradient.

However, limitation by a fixed, time gradient has the disadvantage that this gradient must be selected to be very low in order to assure the factor. This assured low gradient reduces the performance of the variable steering ratio so much that high gradients cannot be implemented depending on the deflection of the steering handle 16. In addition, when using a fixed, time gradient, movement of the vehicle wheels 20 with a consistent deflection of the steering handle 16 and change in the factor cannot be prevented, for example, when the factor changes by means of the vehicle speed.

To improve efficiency, therefore, an improved method for assuring a change in the variable steering ratio of the steering system 10 is proposed below. In the present case, the computing unit 22 is provided to perform the method and comprises for this purpose a computer program having corresponding program code means. In general, however, another computing unit, for example a central vehicle control device, could alternatively be provided for performing the method.

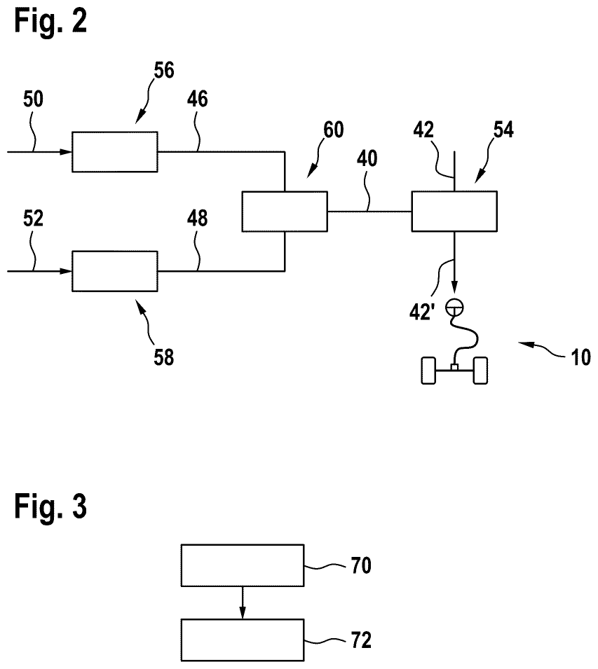

According to the present disclosure, the change in the variable steering ratio is limited by means of a dynamically determined change characteristic 40 (cf. in particular FIG. 2) instead of by means of a fixed value. Preferably, the change in the variable steering ratio in this context is made using a change factor 42, 42′, wherein the change factor 42, 42′ is limited by the change characteristic 40. In the present case, the computing unit 22 comprises a limiting block 54, which is supplied with an unlimited change factor 42 as well as the dynamically determined change characteristic 40, and which determines a dynamic, limited change factor 42′ for the variable steering ratio based on the supplied quantities. The change variable 40 is thus variably configured and can be dynamically adjusted, for example, depending on a current driving and/or steering situation.

In the present case, a time change gradient serves as the change characteristic 40, so that a dynamically adjustable time gradient limitation is used to limit the change in the steering ratio and in particular to limit the change factor 42, 42′.

Furthermore, the change characteristic 40 is dynamically calculated as a function of a current steering specification on the steering handle 16, in the present case in particular as a function of a deflection 50 of the steering handle 16 and a steering speed 52 of the steering handle 16. The change characteristic 40 can be determined, for example, as a function of two partial characteristics 46, 48. A first partial characteristic 46 of the partial characteristics 46, 48 is determined by means of a first calculation block 56 and, as a function of the deflection 50 of the steering handle 16, while a second partial characteristic 48 of the partial characteristics 46, 48 is determined by means of a second calculation block 58 and, at least, as a function of the steering speed 52 of the steering handle 16. The first partial characteristic 46 advantageously corresponds to a minimum gradient, while a maximum gradient is used as the second partial characteristic 48. The two partial characteristics 46, 48 are then supplied to a conversion block 60, which determines the change characteristic 40 as a function of a maximum value from the first partial characteristic 46 and the second partial characteristic 48. In the present case, the maximum value for the time gradient limitation is used directly, by way of example. In principle, however, a second partial characteristic can also be determined as a function of a deflection and a steering speed of a steering handling. Furthermore, it is conceivable to determine the change characteristic alternatively using a characteristic map, which depicts at least one deflection of the steering handle against a steering speed of the steering handle, so that, in principle, a 3D characteristic map for gradient limitation could also be used.

Finally, FIG. 3 shows an exemplary flowchart with the main method steps of the method for effecting the change in the variable steering ratio.

In a method step 70, the change characteristic 40 is determined, for example, as a function of a deflection 50 of steering handle 16 and a steering speed 52 of steering handle 16.

In a method step 72, the change in the variable steering ratio, and in the present case in particular the change factor 42, 42′ used for this purpose, is limited by means of the dynamically determined change characteristic 40. Operational safety can thereby be increased, in particular also in the event that the change factor 42, 42′ is provided by a third party or by an external sensor technology and/or an external control unit, and at the same time improved performance can be achieved. Moreover, by situationally adjusting the change variable 40, movement of the vehicle wheels 20 can be prevented upon accelerating, particularly in the event that the change factor 42, 42′ changes during this driving situation.

The flowchart in FIG. 3 is merely intended to describe, by way of example, a method for effecting the change in the variable steering ratio. In particular, individual method steps may also vary, or additional method steps may be added. For example, it is conceivable to determine the change characteristic 40 as a function of at least two partial characteristics 46, 48, wherein a first partial characteristic 46 of the partial characteristics 46, 48 is a function of a deflection 50 of the steering handle 16 and a second partial characteristic 48 of the partial characteristics 46, 48 is at least a function of a steering speed 52 of the steering handle 16, or to determine the change characteristic using a characteristic map, which depicts at least one deflection of steering handle against a steering speed of the steering handle.

1. A method for assuring a change in a variable steering ratio in a steering system, the steering system being configured as a steer-by-wire steering system that includes (i) an operating unit having at least one steering handle and (ii) at least one wheel steering angle control element operatively connected to the operating unit and configured to change a wheel steering angle of at least one vehicle wheel, the variable steering ratio defining an adjustable gear ratio between a steering specification on the steering handle and the wheel steering angle of the vehicle wheel, the method comprising:
limiting the change in the variable steering ratio is limited via a dynamically determined change characteristic.

2. The method according to claim 1, further comprising:
achieving the change in the variable steering ratio using a change factor; and
limiting the change factor by the change characteristic.

3. The method according to claim 1, wherein the change characteristic includes a time change gradient.

4. The method according to claim 1, further comprising:
determining the change characteristic dynamically as a function of a steering specification on the steering handle.

5. The method according to claim 4, wherein the change characteristic is a dynamic value and/or an absolute value of the steering specification.

6. The method according to claim 1, wherein:
the change characteristic is determined as a function of at least two partial characteristics,
a first partial characteristic of the at least two partial characteristics is determined as a function of a deflection of the steering handle, and
a second partial characteristic of the at least two partial characteristics is determined at least as a function of a steering speed of the steering handle.

7. The method according to claim 6, wherein the change characteristic is determined as a function of a maximum value from the first partial characteristic and the second partial characteristic.

8. The method according to claim 1, wherein the change characteristic is determined using a characteristic map, which at least depicts a deflection of the steering handle against a steering speed of the steering handle.

9. The method according to claim 1, wherein the method is executed during operation of the steering system in a vehicle.

10. A computing unit comprising memory and a processor configured to execute program instructions stored in the memory to execute the method of claim 1.

11. A vehicle comprising:
a steering system configured as a steer-by-wire steering system comprising:
an operating unit with at least one steering handle; and
at least one wheel steering angle control element operatively connected to the operating unit and configured to change a wheel steering angle of at least one vehicle wheel; and
a computing unit configured to limit a change in a variable steering ratio of the steering system via a dynamically determined change characteristic so as to assure a change in the variable steering ratio.

12. The vehicle according to claim 11, wherein the vehicle is a motor vehicle.
